(19) United States
(12) Patent Application Publication
(10) Pub. No.: US 2017/0242643 A1
(43) Pub. Date: Aug. 24, 2017

(54) METHOD AND APPARATUS FOR PRESENTING CONTEXTUAL INFORMATION ON PHYSICAL OBJECTS

(71) Applicants: Gregg H Weiss, Wellington, FL (US); Andrei Paul Averbuch, Cedar Grove, NJ (US)

(72) Inventors: Gregg H Weiss, Wellington, FL (US); Andrei Paul Averbuch, Cedar Grove, NJ (US)

(21) Appl. No.: 15/440,122

(22) Filed: Feb. 23, 2017

Related U.S. Application Data
(60) Provisional application No. 62/298,874, filed on Feb. 23, 2016.

(51) Int. Cl. G06F 3/147; G06F 1/16; G06F 3/01

(52) U.S. Cl. CPC G06F 3/147; G06F 3/011; G06F 1/163; G06F 1/1652; G06F 3/04842

(57) ABSTRACT

Disclosed is a physical object configured to present contextual information. The physical object may be configured to provide an inherent primary functionality while also configured to provide a secondary functionality of presenting the contextual information. Accordingly, the physical object may include a presentation device configured to present the contextual information. Further, the physical object may include one or more of a sensor and a transmitter. The sensor may be configured to sense an environmental variable corresponding to an environment of the physical object. Further, the transmitter may be configured to transmit information to an external reader. Additionally, the physical object may include a processor configured to control the presentation device to present contextual information based on one or more of a value of the environmental variable and information transmitted to the external reader.

### RELATED APPLICATION

Applicants claim the benefit of U.S. provisional application No. 62/298,871, filed on Feb. 23, 2016, which is incorporated herein by reference. It is intended that each of the referenced applications may be applicable to the concepts and embodiments disclosed herein, even if such concepts and embodiments are disclosed in the referenced applications with different limitations and configurations and described using different examples and terminology.

### FIELD OF DISCLOSURE

The present disclosure generally relates to presenting contextual information on a physical object such as, for example, backpack or article of clothing.

### BACKGROUND

In several situations, there is a need for presentation of contextual information to users. Generally, such information may be presented to users on fixed devices such as road-side display screens or portable devices such as smartphones carried by the users.

However, there may be several instances where fixed display devices may not be available to present necessary contextual information to users. For example, users participating in a hiking expedition may require information such as their location and directions to be presented to them on a regular basis. However, the mountainous terrain may present enormous challenges to install and operate fixed display devices to present such information to hikers.

Accordingly, in such cases, users may carry portable display devices to display contextually relevant information to the users. However, the users may be inconvenienced to carry and/or hold the portable display device in order to consume the required information. In cases where the user requires contextual information while performing an activity, requiring the use of hands to hold and/or operate the portable display device may temporarily affect the ability of the users to perform the activity.

Accordingly, there is a need for improved methods, systems and apparatus for facilitating presentation of contextual information to users.

### BRIEF OVERVIEW

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

Disclosed herein is an object configured to be worn and/or carried by a user which is further enabled to present contextual information to the user. Accordingly, the object may include one or more presentation devices such as, but not limited to, display devices such as E-ink displays, sound reproduction devices and braille displays. Further, the object may include a processor configured to control the one or more presentation devices and an energy source, such as for example, a battery configured to provide power.

In general, the object may be configured to provide a primary functionality other than presenting contextual information. For example, the object may be a backpack whose primary functionality may be to store one or more physical items. As another example, the object may be a t-shirt whose primary functionality may be to cover the torso of a user.

In order to present contextual information, the object may be configured to interact with an environment surrounding the object.

For example, in some embodiments, the object may include a communications module operative to communicate with other communications modules within an environment, on a common protocol. In other embodiments, the object may include optical indicia such as a bar code or QR code that may be read by an external system. Accordingly, the external system may identify the object and wirelessly transmit contextual information to the object to be presented on the one or more presentation devices.

As another example, in some embodiments, the object may include one or more transmitters configured to wirelessly transmit a signal. Further, the external system may be configured to detect the signal and in response wirelessly transmit contextual information to the object.

As yet another example, in some embodiments, the object may include one or more sensors configured to detect an environmental variable. Based on a value of the environmental variable, the processor may be configured to present the contextual information to the user.

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 illustrates a block diagram of an operating environment consistent with the present disclosure.

FIGS. 2A and 2B illustrates a backpack configured to present contextual information in accordance with some embodiments.

FIGS. 3A and 3B illustrates a view of inner compartments of the backpack configured to present contextual information in accordance with some embodiments.

FIG. 4 is a block diagram of a system presenting contextual information on physical objects in accordance with some embodiments.

FIG. 5A illustrates a splash page of a mobile app for facilitating presentation of contextual information on physical objects in accordance with some embodiments.

FIG. 5B illustrates a menu screen of a mobile app for facilitating presentation of contextual information on physical objects in accordance with some embodiments.

FIG. 6A illustrates a photo selection screen of a mobile app for facilitating presentation of contextual information on physical objects in accordance with some embodiments.

FIG. 6B illustrates a photo preview screen of a mobile app for facilitating presentation of contextual information on physical objects in accordance with some embodiments.

FIG. 7A illustrates a text creation screen of a mobile app for facilitating presentation of contextual information on physical objects in accordance with some embodiments.

FIG. 7B illustrates an animation selection screen of a mobile app for facilitating presentation of contextual information on physical objects in accordance with some embodiments.

FIG. 8A illustrates an animation preview screen of a mobile app for facilitating presentation of contextual information on physical objects in accordance with some embodiments.

FIG. 8B illustrates a drawing editor screen of a mobile app for facilitating presentation of contextual information on physical objects in accordance with some embodiments.

FIG. 9A illustrates a photo preview screen of a mobile app for facilitating presentation of contextual information on physical objects in accordance with some embodiments.

FIG. 9B illustrates a transmission status screen of a mobile app for facilitating presentation of contextual information on physical objects in accordance with some embodiments.

FIG. 9C illustrates a settings screen of a mobile app for facilitating presentation of contextual information on physical objects in accordance with some embodiments.

FIG. 10 is a flow chart illustrating the stages of operating a platform consistent with embodiments of the present disclosure.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. §112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of presenting contextual information on physical objects, embodiments of the present disclosure are not limited to use only in this context.

I. Platform Overview

Consistent with embodiments of the present disclosure, a method and system for presenting contextual information on physical objects is provided. This overview is provided to introduce a selection of concepts in a simplified form that are further described below. This overview is not intended to identify key features or essential features of the claimed subject matter. Nor is this overview intended to be used to limit the claimed subject matter's scope. The method and system for presenting contextual information on physical objects may be used by individuals or companies to present contextual information to one or more users based on a context.

According to some embodiments, the physical object according to the disclosure includes a backpack with a remotely controllable flexible display device such as E-ink display. Further, in addition to providing utility of displaying contextual information the flexible display device may be used as decoration on the surface of the backpack.

Additionally, the flexible display may be controlled remotely through Bluetooth or other remote control protocols from a compatible computer system such as a mobile device or a desktop computer equipped with Bluetooth or other appropriate remote communication capabilities. In an instance, the mobile device may be operated by the user carrying the backpack.

Further, the flexible display may be powered by a portable rechargeable battery and/or a solar panel.

Furthermore, a software application running on the mobile device may be configured to acquire image/video data either locally from the mobile device or from the internet. Subsequently, the acquired image/video may then be transmitted to a computer equipped with memory. Further, the computer may be in communication with the flexible display in order to display the image/video to be displayed on the flexible display.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

II. Platform Configuration

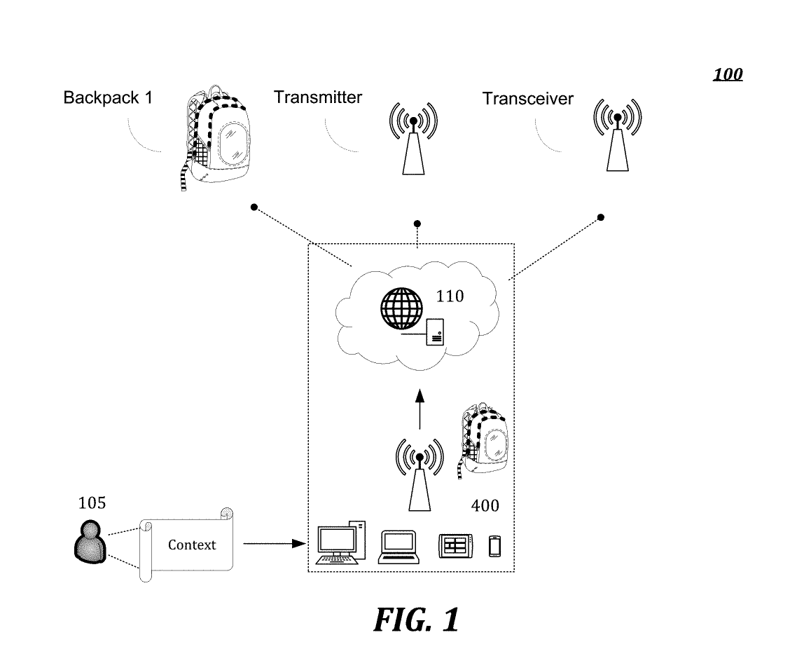

FIG. 1 illustrates one possible operating environment through which a platform consistent with embodiments of the present disclosure may be provided. By way of non-limiting example, contextual information presentation platform 100 (referred to as “platform”) may be hosted on a centralized server 110, such as, for example, a cloud computing service. Alternatively, the platform 100 may be implemented in the form of a computing device 400 attached to a physical object such as a backpack. A user 105 may access platform 100 through a software application. The software application may be embodied as, for example, but not be limited to, a website, a web application, a desktop application, and a mobile application compatible with a computing device 400.

In some embodiments, as illustrated in FIG. 1, the backpack including the computing device 400 may interact with an external device present in an environment of the backpack. Accordingly, the platform 100 may be configured to communicate with the external device such as, but not limited to, a transmitter, a receiver, a transceiver and another backpack including the computing device 400. For example, the platform 100 included in the backpack may include one or more of a short range transmitter, a short range receiver and a short range transceiver. Additionally, in some embodiments, the platform 100 may include one or more sensors configured to sense an environmental variable. For example, the platform 100 may include a GPS receiver for sensing a location of the platform 100. As another example, the platform 100 may include an activity sensor configured to detect an activity of a user wearing the backpack containing the platform 100.

Further, the platform 100 may include a presentation device such as a display device and a sound reproduction device. For instance, the backpack containing the platform 100 may include an E-ink display on an external side of the backpack. Additionally, the platform 100 may be configured to present contextual information on the presentation device based on an interaction of the platform 100 with the environment. For instance, in some embodiments, the content displayed on the E-ink display may be based on the location of the platform 100 as sensed by the GPS receiver. In another instance, the content displayed on the E-ink display on the backpack may be based on output values of the activity sensor. In yet another instance, the content displayed on the E-ink display may be based on signals transmitted by the transmitter included in the platform 100. The signals may be received by a transceiver in communication with the platform 100. Subsequently, in response, the transceiver may transmit contents to the platform 100 that may be displayed on the E-ink display.

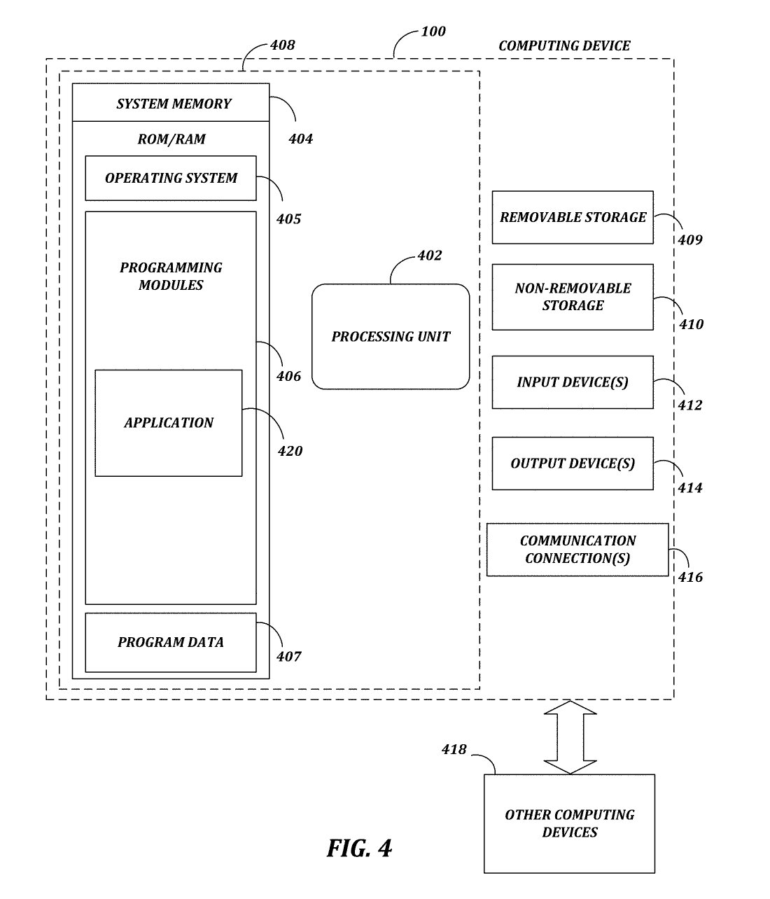

As will be detailed with reference to FIG. 4 below, the computing device 400 through which the platform may be accessed may comprise, but not be limited to, for example, a desktop computer, laptop, a tablet, or mobile telecommunications device. Though the present disclosure is written with exemplary reference to a mobile telecommunications device, it should be understood that any computing device may be employed to provide the various embodiments disclosed herein.

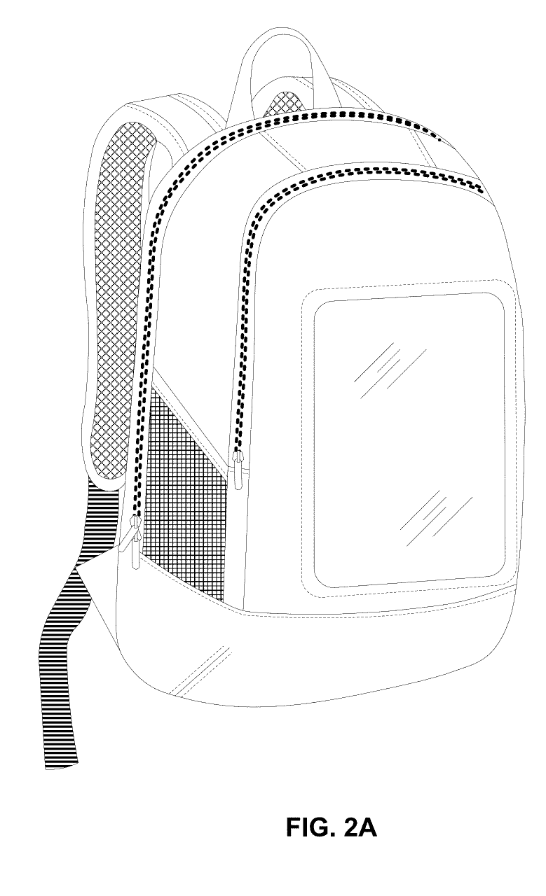

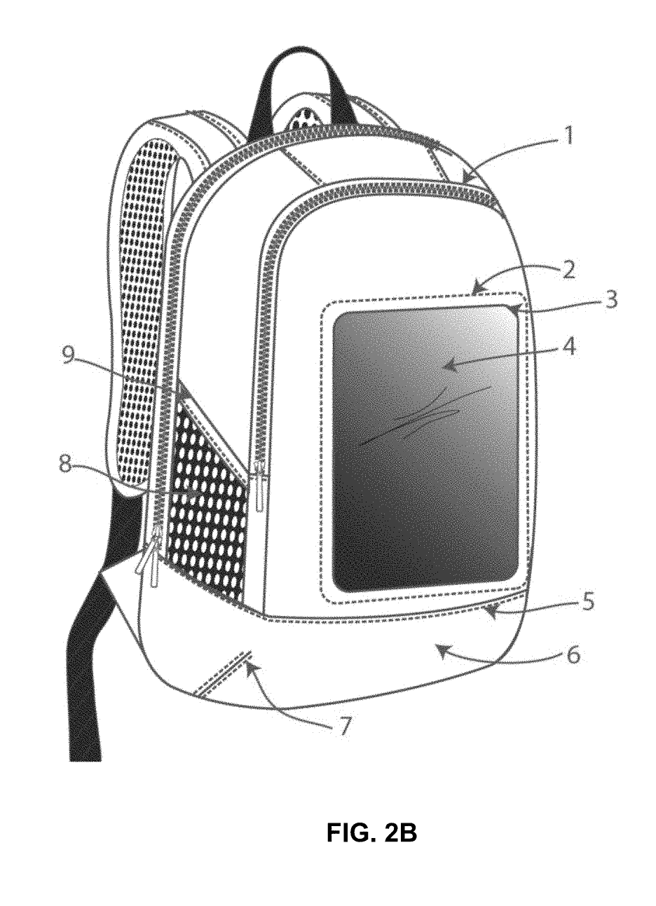

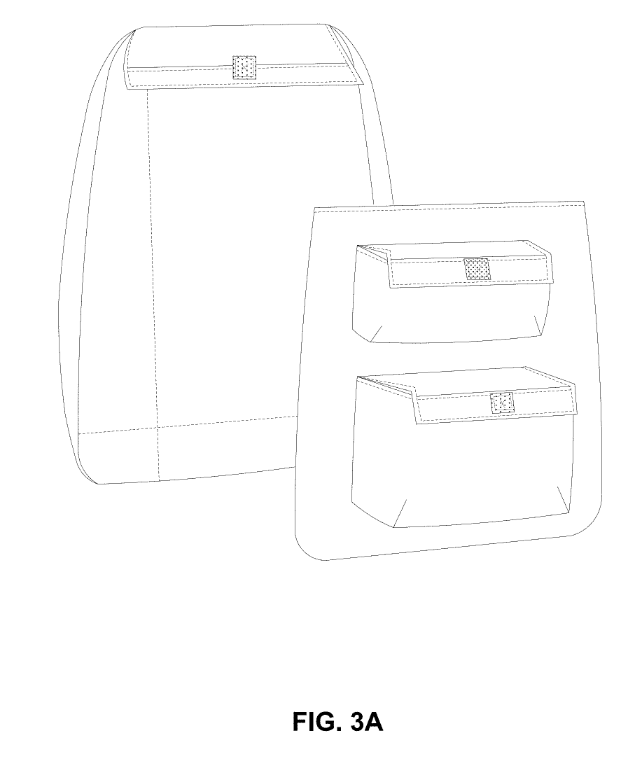

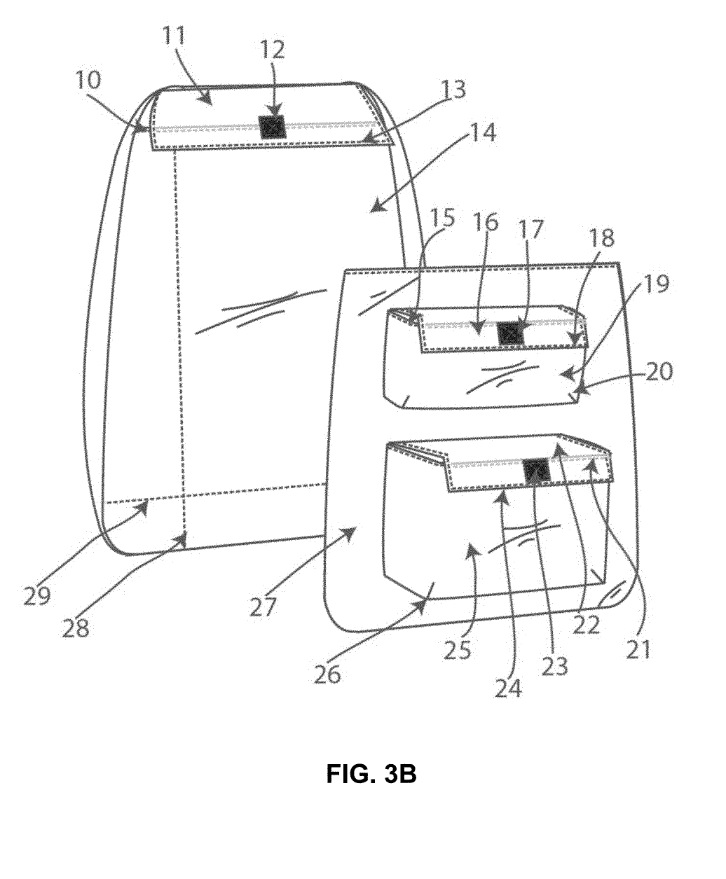

The following key refers to reference numerals illustrated in FIGS. 2A-3B.

| | | |
|---|---|---|
| 1 | FRONT POCKET | HOUSES AND PROTECTS ALL |
| | OPENING | MECHANICS #30 |
| | | THROUGH #35 |
| 2 | FRONT WINDOW | SECURES PU/VINYL WINDOW |
| | EDGE STITCHING | IN PLACE |
| 3 | FRONT WINDOW | CREATES OPENING FOR |
| | EDGE | PICTURE TO SHOW FULL |
| | | SCREEN |
| 4 | FRONT WINDOW | PROTECTS PICTURE SCREEN |
| | CLEAR PU/VINYL | #30 |
| 5 | BOTTOM PIECING | SECURES BOTTOM PIECING |
| | EDGE STITCH | #6 |
| 6 | PADDED BOTTOM | SECURES ALL MECHANICS |
| | PIECING | #30 THROUGH #35 |
| 7 | DART WITH | CREATES BOTTOM PIECE |
| | STRADDLE STITCH | SHAPE |
| 8 | ANGLED MESH | FASHION POCKET SECURES |
| | POCKET | WATER BOTTLES ETC |
| 9 | ELASTIC BINDING | CREATES ELASTICITY FOR |
| | | POCKET TO HOLD ITEMS |
| | | SNUG |
| 10 | POUCH-1A OPENING | ALLOWS US TO PLACE |
| | WITH EDGESTITCH | PICTURE SCREEN #30 |
| | IN CLEAR | INTO WINDOW |
| 11 | POUCH-1A FLAP | PROTECTS PICTURE SCREEN |
| | IN CLEAR | #30 BY INCLOSING IT |
| | PU/VINYL | |
| 12 | VELCRO CLOSURE | CLOSURE FOR FLAP, SO |
| | | NOTHING SLIPS OUT |
| 13 | POUCH-1A FLAP | MAKES SMOOTH EDGES SO |
| | EDGESTITCH | NO MECHANICS WILL |
| | | SNAG |
| 14 | POUCH-1A | HOLDS PICTURE SCREEN |
| | | #30 |
| 15 | POUCH-2B OPENING | ALLOWS US TO PLACE |
| | WITH EDGESTITCH | BATTERY #31 |
| | IN CLEAR | INSIDE |
| 16 | POUCH-2B FLAP | PROTECTS BATTERY #31 |
| | IN CLEAR | BY INCLOSING IT |
| | PU/VINYL | |
| 17 | VELCRO CLOSURE | CLOSURE FOR FLAP, SO |
| | | NOTHING SLIPS OUT |
| 18 | POUCH-2B FLAP | MAKES SMOOTH EDGES SO |
| | EDGESTITCH | NO MECHANICS WILL SNAG |
| 19 | POUCH-2B | HOLDS BATTERY #31 |
| 20 | POUCH-2B Edge | CREATES BATTERY #31 |
| | Dart | DEPTH |
| 21 | POUCH-3C OPENING | ALLOWS US TO PLACE |
| | WITH EDGESTITCH | COMPUTER #32 |
| | IN CLEAR | INSIDE |
| 22 | POUCH-3C FLAP | PROTECTS COMPUTER |
| | IN CLEAR | #32 BY |
| | PU/VINYL | INCLOSING IT |
| 23 | VELCRO CLOSURE | CLOSURE FOR FLAP, SO |
| | | NOTHING SLIPS OUT |
| 24 | POUCH-3C FLAP | MAKES SMOOTH EDGES SO |
| | EDGESTITCH | NO MECHANICS WILL SNAG |
| 25 | POUCH-3C | HOLDS COMPUTER #32 |
| 26 | POUCH-3C EDGE | CREATES COMPUTER #32 |
| | DART | DEPTH |
| 27 | POUCH PANEL | HOLDS POUCHES 2B & 3C, |
| | | ALSO CREATES TUNNEL FOR |
| | | CORDS #33 THROUGH |
| | | #35 TO RUN |
| 28 | VERTICAL SEAM | HOLDS PICTURE SCREEN #30 IN |
| | CLOSURE | PLACE SNUG |
| 29 | HORIZONTAL SEAM | HOLDS PICTURE SCREEN #30 IN |
| | CLOSURE | PLACE SNUG |
| 30 | PICTURE SCREEN | LOADS PICTURE SENT FROM |
| | | PHONE/COMPUTER/TABLET APP |
| 31 | BATTERY | CONNECTS TO COMPUTER #32 |
| 32 | COMPUTER | CONNECTS TO BATTERY #31 BY |
| | | WAY OF CORD #35, CONNECTS |
| | | TO PICTURE SCREEN #30 |
| | | BY WAY OF CORDS |
| 33 | SOURCE FLAT | CONNECTS FROM COMPUTER TO |
| | CORD | PICTURE SCREEN, SENDING |
| | | INFO FROM THE APP TO THE |
| | | COMPUTER TO THE SCREEN |
| 34 | GATE FLAT CORD | CONNECTS FROM COMPUTER TO |
| | | PICTURE SCREEN, SENDING |
| | | INFO FROM THE APP TO THE |
| | | COMPUTER TO THE SCREEN |
| 35 | BATTERY CORD | CONNECTS TO COMPUTER |
| | | #32 TO KEEP IT |
| | | RUNNING/CHARGED |

III. Platform Operation

According to the present disclosure, methods and systems for presenting contextual information on physical objects are provided. Accordingly, a method, system and apparatus for facilitating presentation of contextual information to users are provided. In accordance with some embodiments, the apparatus may include an object that may be configured to provide a primary functionality. In general, the primary functionality may be other than presenting contextual information. For example, the object may be a backpack whose primary functionality may be to store one or more physical items. As another example, the object may be a t-shirt whose primary functionality may be to cover the torso of a user. As yet another example, the object may be a hat configured to be worn over the head of a user as an accessory. Other examples of the object may include, but are not limited to, shoes, blankets, jackets, umbrellas and so on. In some embodiments, the object may be configured to be carried and/or worn by the user.

Further, the object may be may include one or more presentation devices such as, but not limited to, display devices, sound reproduction devices and braille displays. In some embodiments, the display devices may include, one or more of, but are not limited to, liquid crystal display (LCD) screen, Light emitting diode (LED) screen, Organic LED (OLED) screen and electronic-ink based display screen. In some embodiments, the one or more presentation devices may include a tablet computer or a smartphone. Additionally, the object may include a processor configured to control the one or more presentation devices and an energy source, such as for example, a battery in order to provide power. Further, in some embodiments, the backpack may include a solar charging panel configured to convert solar energy into electricity to charge the battery or directly power one or more active devices on the backpack such as a presentation device or the processor.

For example, as illustrated in FIG. 1, the object such as exemplarily illustrated as a backpack, may include a presentation device such as an E-ink based display screen. Further, the presentation device may be attached to the object. Exemplary details regarding the technical characteristics of the backpack are provided in Appendix A and B.

In some embodiments, the presentation device may be removably attached to the object. Accordingly, the user may remove the presentation device, such as a tablet computer, and utilize the presentation device independent of the object. For example, the backpack may be provided with an external pouch configured to accommodate the presentation device. Further, the pouch may include a transparent portion configured to cover the screen of the presentation device. Accordingly, the presentation device may be protected while also enabling presented contents to be viewed and/or heard. Further, the pouch may be configured to be secured at one or more openings by means of a fastener such as Velcro fastener, zip fastener or snap button based fastener. Accordingly, after placing the presentation device within the pouch, the fastener may be fastened to ensure that the presentation device is secured within the pouch.

In some embodiments, the presentation device may be permanently attached to the object. Accordingly, the object such as the backpack may be provided with one or more compartments to house the presentation device. Further, one or more openings of the compartments may be fastened permanently, for example, using glue or sewing. This may ensure that the presentation device is always attached to the object in order to present the contextual information.

In some embodiments, the presentation device may be attached to the object in such a way, that the contextual information presented may be consumed by the user. For instance, in case of the object such as an umbrella, the presentation device, such as a flexible E-ink based display screen, may be attached to the inner-side of the canopy. Accordingly, while using the umbrella, the user may be presented with contextual information such as for example, weather information associated with the current location of the user.

In some embodiments, the presentation device may be attached to the object in such a way, that the contextual information presented may be conveniently consumed by other users proximal to the user. For instance, in case of the object such as a backpack as illustrated in FIGS. 2A-2B, the presentation device, such as a flexible E-ink display screen may be attached to an external portion of the backpack that is exposed to the environment while being worn by the user. Accordingly, contextual information presented on the backpack may be consumed by other users who may be located behind the user, separated by a short distance.

For example, in a hiking expedition, the user carrying the backpack may be ahead of the other users. Accordingly, contextual information such as map of the mountain, places of interest, current location, temperature, effort level, heart rate of the user and any hiking instructions/tips may be presented on the presentation device for the benefit of the other users close to the user. Accordingly, the backpack may include one or more sensors such for detecting environmental variables such as temperature, pressure, altitude, location etc. Further, the one or more sensors may also include biometrical sensors to detect the user's physiological condition. In some embodiments, the one or more sensors may be situated on the straps of the backpack. Further, in some other embodiments, the one or more sensors and associated electronic circuitry including the processor and transmitter/receiver may be situated in one or more compartments or pockets within the backpack as illustrated in FIGS. 3A-3B.

As another example, the user carrying the backpack may select a contextual information such as a status associated with the user to be presented on the presentation device. The status may convey information, for example, regarding an activity that the user is currently engaged in such as the title of the song that the user is listening. Accordingly, the processor included in the backpack may be configured to interact with a media device, such as an MP3 player, associated with the user. For instance, the backpack may include a short range transceiver, such as a Bluetooth transceiver, for communicating with the MP3 player in order to receive information such as title/artist of the song currently being played, playlist etc.

Similarly, the status may convey information regarding an event such as a concert that they user may be going to. Accordingly, the processor may be configured to communicate wirelessly with a personal electronic device of the user such as a smartphone. For instance, the processor may be configured to communicate with the smartphone of the user via the Bluetooth transceiver. Further, a presentation app executing on the smartphone may access event related information from, for example, a calendar app executing on the smartphone. Accordingly, based on a time and place associated with the event as retrieved from the calendar app and a current time and location of the user, the status may be automatically determined and presented on the presentation device.

Likewise, the status may convey a current mood of the user that may be determined automatically based on analysis of the user's behavior. For instance, the one or more sensors may detect a gait of the user and based on a predetermined correlation between gait and mood, the mood of the user may be automatically determined and presented on the presentation device.

In general, the user may select an option to automatically determine the status of the user and present the status on the presentation device to the other users. Accordingly, the user may be able to publish information of their choice for the benefit of other users who may be close enough to the user to consume the information.

As another example, the contextual information may be advertisements that may be presented on the backpack for the benefit of the other users. Further, the processor may be configured to select an advertisement to be presented based on a context such as, for example, a location of the backpack. For example, when the user carrying the backpack is waking on sidewalk, an advertisement regarding a restaurant in the vicinity of the user's current location may be selected and presented on the presentation device. Further, the advertisement may include a QR code that the other users may capture using a camera and avail special benefits such as discounts or chance to win prizes based on the QR code. Further, the user may be rewarded for presenting the advertisement by providing a discount coupon or a payment.

As yet another example, where the user is a student, the contextual information may include information such as name of the student in order to enable a teacher to identify or locate the student. Further, in some embodiments, the contextual information may include a history of locations visited by the backpack over a period of time. Accordingly, for example, a parent may be able to view the places where a child carrying the backpack has been through on a day.

As another example, the contextual information may include emergency information, such as medical information, regarding the user in an event such as for e.g. medical emergency or accident. This may enable medical professionals to provide appropriate treatment to the user based on the medical information. In some embodiments, the presentation of the medical information may be triggered based on predetermined values of the one or more sensors included in the backpack. For example, when value of a biometrical variable such as body temperature, heart rate or blood pressure is detected to be of a dangerously abnormal value, the medical information of the user may be presented. Further, in some embodiments, along with the medical information, the values of the one or more biometrical variables may also be presented.

In some other embodiments, the medical information may be presented upon a triggering event caused by an interaction of an external device with the backpack. For example, the external device may be carried by a medical professional and configured to detect presence of the backpack via RF detection. Accordingly, the external device may prompt the medical professional to enter a special code in order to activate presentation of the medical information. Subsequently, the external device may transmit a control signal to the backpack to trigger presentation of the medical information. As a result, confidentiality of the medical information may be maintained and access provided to authorized users.

As yet another example, the contextual information may include emergency alert information. Accordingly, the backpack may be configured to receive emergency alert information from government alert systems and present the emergency alerts. These emergency alerts may be triggered by geo-based location and beacons as well as by mobile devices paired with the backpack. For example, Amber Alerts with Photo BOLO messages for missing persons or known criminals in the area may be received and presented on the backpack.

As another example, the contextual information may include a list of physical items present inside the backpack. In some embodiments, one or more physical items may be tagged with RFIDs. Further, the backpack may include an RFID reader to detect the RFIDs and accordingly present the list of physical items. As a result, the user may know the contents of the backpack after packing without having to open the backpack to physically inspect if an item of interest is present in the backpack. For instance, a user-interface provided on the presentation device may be configured to receive a request from a user for displaying the contents of the backpack. Alternatively, the contents of the backpack may be displayed continuously on the presentation device.

As yet another example, the contextual information may be based on one or more other backpacks located in the vicinity of the backpack. For example, a group of users each carrying a backpack according to the embodiments of the present disclosure may wish to synchronize the backpacks by exchanging information and subsequently presenting the received information on respective presentation devices. For example, the contextual information may include social networking and/or gaming related information such as maps.

Further, in some embodiments, a first backpack may be configured to detect the presence of a second backpack nearby and subsequently, each of the first backpack and the second backpack may be configured to present content in a collaborative manner. For example, a first contextual information may be presented on the first backpack while a second contextual information may be presented on the second backpack.

Further, in some embodiments, the backpack may be configured to communicate with a personal electronic device of the user such as a smartphone in order to receive the contextual information. For instance, a mobile app executing on the smartphone may be configured to select/create content and transmit the content to the backpack for subsequent presentation on the presentation device.

Additionally, in some embodiments, the mobile app may include a third party monitoring feature. Accordingly, a third party (e.g., parent of a schoolchild) may be able to monitor what content is being transmitted and displayed on the backpack and also approve/block the content.

In some embodiments, the mobile device may be configured to execute the Android operating system or iOS operating system.

In some embodiments, in order to facilitate presentation of contextual information, an E-ink display, such as that commercially available from Plastic Logic as provided in Appendix C, may be attached to the back panel of a backpack. Further, the E-ink display may be housed in a compartment of the backpack covered by a protective transparent plastic sheet. Accordingly, the contextual information presented on the E-ink display may be viewed while also protecting the E-ink display from bruising and liquids.

According to some embodiments, as exemplarily depicted in FIGS. 2A-2B, a backpack may be provided with an E-ink display attached inside a see-through protective compartment on the back-side of the backpack. The E-ink display may be connected by wire connectors to a computer onboard the backpack. Further, the computer may be configured for acquiring image/video data from a remote device such as a mobile device operated by a user carrying the backpack. Accordingly, the computer may be connected to the E-ink display. Further, each of the E-ink display and the computer may be powered by a battery.

In some embodiments, each of the battery, the computer may be placed inside specific compartments in the backpack, which may be custom built according to respective dimensions of the battery and the computer. Further, the battery may be connected to a solar panel attached to the backpack. The solar panel may be configured to provide electricity for re-charging the battery and optionally powering the computer directly. Further, the electric wire connectors connecting the computer, the battery, the solar panel and the E-ink display may be placed in a compartment made of protective material to prevent damage and contact with undesirable elements or liquids.

In some embodiments, in order to implement the backpack configured to present contextual information, the BlueZ Blootooth library may be installed on the computer. Further, by using a Bluetooth dongle, the E-ink display may be equipped with Bluetooth capabilities.

Additionally, mobile device with Bluetooth capability may be associated with the backpack. Further, an app, based on, for example, iOS or Android, and executable on the mobile device may be configured to receive photos/videos from the camera of the mobile device, memory of the mobile phone or from sources such as the internet. Subsequently, the app may be configured to send the photos/video via Bluetooth to the E-ink display which may then display the photos/videos on the backpack.

In an exemplary embodiment, the backpack may include a portable battery which outputs the proper voltage for powering a display controller of the E-ink display. Further, the backpack may contain a battery pocket for accommodating the portable battery. Additionally, the battery pocket may allow for a wire to supply electricity to the display controller of the E-ink display. Further, the battery pocket may allow for a wire to supply electricity from the solar panel to the battery for re-charging. Further, the backpack may include controller pocket for accommodating the display controller with Bluetooth capabilities installed. Further, the controller pocket may allow for a wire from the battery to be connected to the display controller. Accordingly, the controller pocket may allow for electronic connectors to go from the display controller to the E-ink display.

Additionally, the controller pocket may allow for air to transpire between the outside and inside of the controller pocket for cooling purposes, although the display controller may not remain in an activated condition permanently since E-ink display does not require electricity to maintain a displayed image.

Further, the backpack may include a display pocket for accommodating the E-ink display. The exterior facing wall of the display pocket may be manufactured of transparent, flexible and protective plastic, which is connected to the backpack on its edges in a water-proof manner. Accordingly, the areas of the E-ink display which connect to wire ribbons may be reinforced with molded and/or 3D printed plastic enclosures which may be affixed to the backpack. Accordingly, the backpack may provide protection for the wire ribbons connecting to the display controller.

According to some embodiments, presentation of the contextual information on the physical object, such as the backpack, may be based on a Client-Server model. Accordingly, a mobile phone operated by the user wearing the backpack may include a Native application executable on the mobile phone that functions as a Client. The client may provide functionalities corresponding to “move next”, “move previous”, “clear carousel”, “take and send a photo” and “select and send an existing picture” to the Server.

Further, the Server may include an application programmed in, for example, C language. Additionally, the server may be configured to start and register with the Bluetooth transceiver onboard and open a socket for listening via Bluetooth.

The client may be configured to communicate by connecting through the Bluetooth transceiver by opening a socket and communicating using a simple proprietary protocol. The protocol may include passing of a four character command as follows:
prev—show previous image in the carousel
next—show next image in the carousel
clear—remove all images but the first from the carousel
load—load a new image to the carousel

Following the four character command, the image file data in binary may be transmitted.

According to some other embodiments, presentation of the contextual information on the physical object, such as the backpack, may be based on Project Cobia consisting of two software components: one mobile (e.g. an android app) and one onboard the backpack (e.g. a C/C++ daemon).

The mobile device may need to be paired to a Bluetooth server onboard the backpack. Further, the server may be hard coded into the Android app.

Additionally, the mobile app may provide the following three functions:

1. Rotate the images to the left. Open a Bluetooth socket, push the text “next” and then close the socket.

2. Rotate the images to the right. Open a Bluetooth socket, push the text “previous” and then close the socket.

3. Take a photo and save it to a file, encode the file to a monochrome file and push the text “load” and then the monochrome file to the mobile device where the daemon may be configured to receive it.

The daemon may be a socket server configured to start automatically using a start script. The daemon may be further configured to open a Bluetooth socket and wait for something to connect to it.

When the daemon starts up, the image files from a directory may be put into an array creating a carousel. The daemon may manage a number of stock images that may be previously stored onboard the backpack. Further, the daemon may use the script that were supplied with the computer to push an image file to the E-ink display.

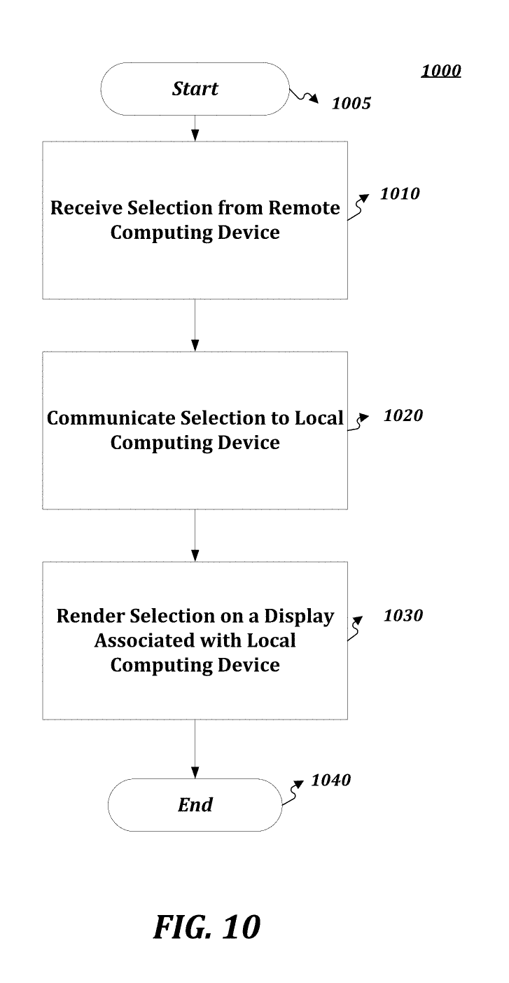

FIG. 10 is a flow chart setting forth the general stages involved in a method 1000 consistent with an embodiment of the disclosure. Method 1000 may be implemented using a computing device 400 as described in more detail below with respect to FIG. 4 in conjunction with a remote local computing device (e.g., a mobile phone).

Although method 1000 has been described to be performed by computing device 400, it should be understood that, in some embodiments, different operations may be performed by different networked elements in operative communication with computing device 400. For example, server 110 and/or computing device 400 may be employed in the performance of some or all of the stages in method 1000. Moreover, server 110 may be configured much like computing device 400 and, in some instances, be one and the same embodiment.

Although the stages illustrated by the flow charts are disclosed in a particular order, it should be understood that the order is disclosed for illustrative purposes only. Stages may be combined, separated, reordered, and various intermediary stages may exist. Accordingly, it should be understood that the various stages illustrated within the flow chart may be, in various embodiments, performed in arrangements that differ from the ones illustrated. Moreover, various stages may be added or removed from the flow charts without altering or deterring from the fundamental scope of the depicted methods and systems disclosed herein. Ways to implement the stages of method 1000 will be described in greater detail below.

Method 1000 may begin at starting block 1005 and proceed to stage 1010 where a selection of a content may be made for display on a physical item (e.g., a backpack) comprising local computing device 400. The selection may be made by a remote computing device connected to the physical item. From stage 1010, method 1000 may advance to stage 1020 where the selection is transmitted from the mobile computing device to computing device 400. Transmission may occur via, for example, various communication protocols, including, but not limited to, Bluetooth. Once computing device 400 receives the selection (i.e., the content to be displayed) in stage 1020, method 1000 may continue to stage 1030 where computing device 400 renders the content on a display device associated with the content. Details associated with the display device are submitted in an appendix to this disclosure. Method 1000 may then end at stage 1040.

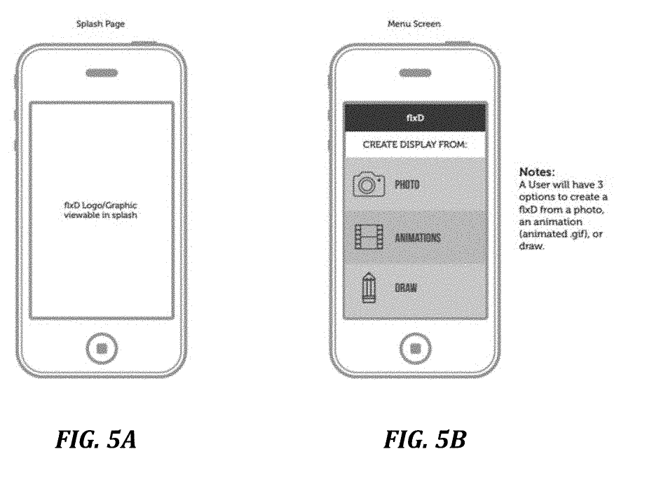

In some embodiments, a mobile app for facilitating presentation of contextual information on a physical object such as a backpack may be provided. Sample screens of the mobile app are illustrated in FIG. 5 to FIG. 9.

When initialized, the mobile app may present a splash page to a user as illustrated in FIG. 5A. The splash page may include a logo and/or a graphic corresponding to a presentation device, such as an E-ink display included in the physical object such as a backpack. Subsequently, the mobile app may be configured to present a menu screen as illustrated in FIG. 5B. As exemplarily illustrated, the menu screen may provide multiple options for selecting the content to be presented on the presentation device such as the E-ink display on the backpack. Accordingly, the user may select the content from a photo, an animation or draw the content.

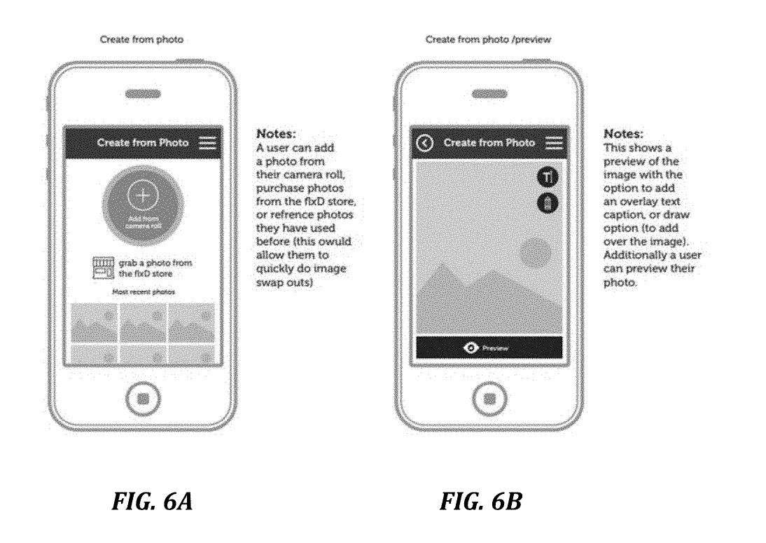

If the user selects the photo option, a screen as illustrated in FIG. 6A may be presented. As shown, the interface may allow the user to add a photo from a gallery application executing on the mobile device or captured from the camera of the mobile device. Alternatively, the interface may allow the user to obtain a photo from a photo store for a fee. Further, the interface may display the most recently selected photos. Accordingly, the user may conveniently select a photo to be displayed on the E-ink display.

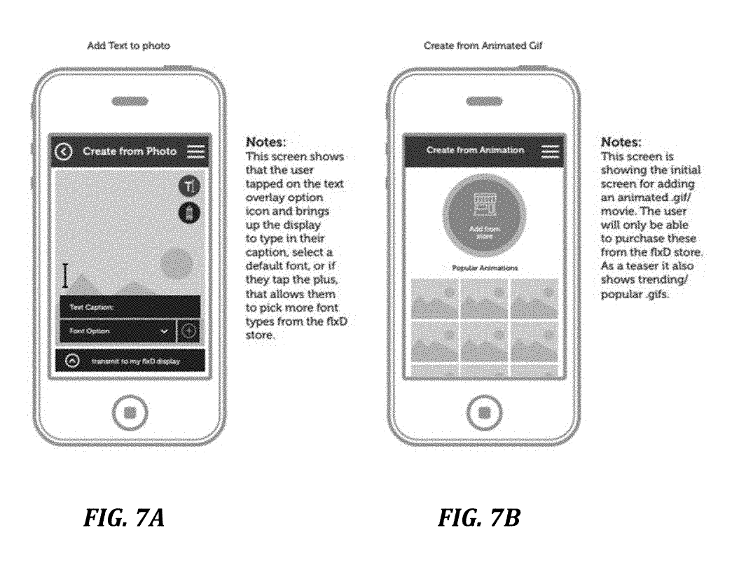

Upon selecting a photo, the user may be presented a photo preview screen as illustrated in FIG. 6B. Additionally, the photo preview screen may include options to include a text overlay on the photo or allow the user to draw over the photo. Accordingly, if the user selects the option to overlay text, a text creation screen as illustrated in FIG. 7A may be presented. As shown, the user may be allowed to choose font, size, color and so on associated with the text. Further, a text box may be provided to receive the text entered by the user.

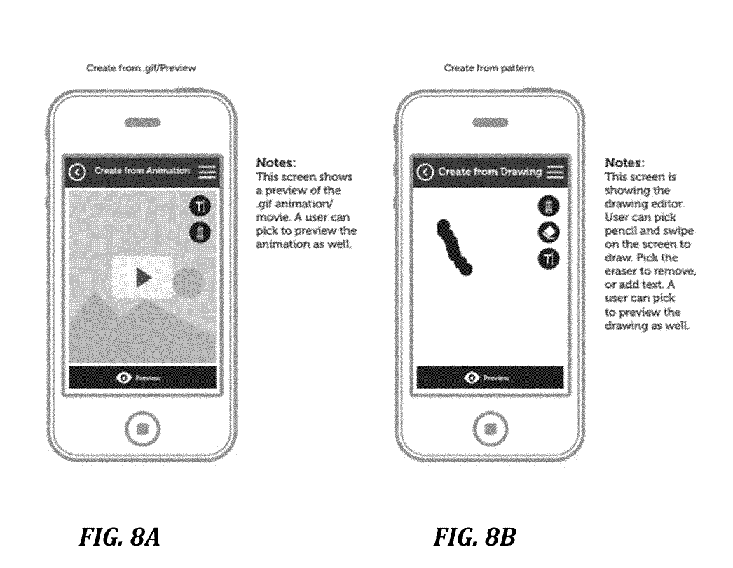

Further, if the user selects the option of presenting animation/GIF, an animation selection screen may be presented to the user as shown in FIG. 7B. As illustrated, the animation screen may allow the user to obtain an animation video or a GIF from a store for a fee. Additionally, the animation screen may display animations that may be currently popular or trending. Accordingly, the user may select an animation of choice. Subsequently, the mobile app may present an animation preview screen as illustrated in FIG. 8A. Once the user previews the animation, the user may confirm selection of the animation to be displayed on the E-ink display of the backpack.

In case the user selected the draw option in the menu screen, the user may be presented with a drawing editor as illustrated in FIG. 8B. The drawing editor may provide tools such as freehand drawing tool, pre-determined shapes tool, eraser tool and text overlay tool and so on.

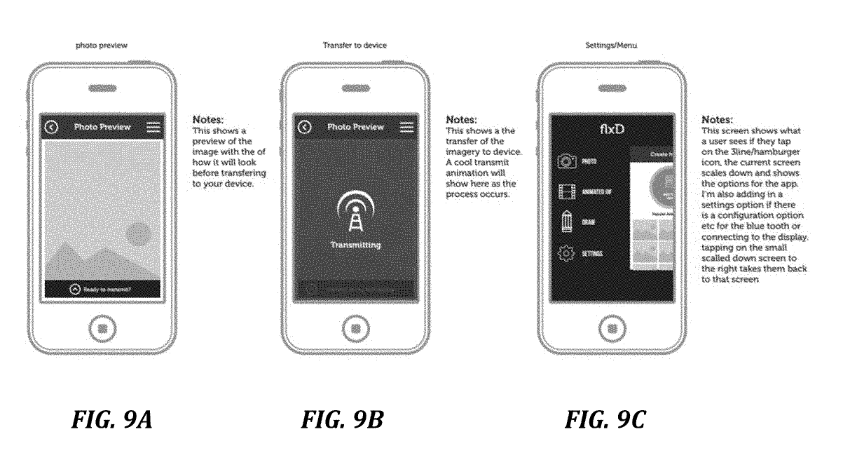

Once the user has either selected and/or created a content such as a photo/video, the mobile app may present a preview screen as illustrated in FIG. 9A. Subsequently, when the user confirms transmission of the photo/video to the E-ink display, a transmission status screen may be displayed to the user as illustrated in FIG. 9B. Further, the mobile app may also present a settings screen to enable the user to change configuration of the mobile app as illustrated in FIG. 9C.

IV. Platform Architecture

The contextual information presentation platform 100 may be embodied as, for example, but not be limited to, a website, a web application, a desktop application, and a mobile application compatible with a computing device. The computing device may comprise, but not be limited to, a desktop computer, laptop, a tablet, or mobile telecommunications device. Moreover, the contextual information presentation platform 100 may be hosted on a centralized server, such as, for example, a cloud computing service. Although method 200 has been described to be performed by a computing device 400, it should be understood that, in some embodiments, different operations may be performed by different networked elements in operative communication with computing device 400.

Embodiments of the present disclosure may comprise a system having a memory storage and a processing unit. The processing unit coupled to the memory storage, wherein the processing unit is configured to perform the methods described herein.

FIG. 4 is a block diagram of a system including computing device 400. Computing device 400 may be integrated into a physical object comprising a battery power supply and a flexible display. Computing device 400 may further comprise memory storage and processing unit may be implemented in a computing device, such as computing device 400 of FIG. 1. Any suitable combination of hardware, software, or firmware may be used to implement the memory storage and processing unit. For example, the memory storage and processing unit may be implemented with computing device 400 or any of other computing devices 418, in combination with computing device 400. The aforementioned system, device, and processors are examples and other systems, devices, and processors may comprise the aforementioned memory storage and processing unit, consistent with embodiments of the disclosure.

With reference to FIG. 4, a system consistent with an embodiment of the disclosure may include a computing device, such as computing device 400. In a basic configuration, computing device 400 may include at least one processing unit 402 and a system memory 404. Depending on the configuration and type of computing device, system memory 404 may comprise, but is not limited to, volatile (e.g. random access memory (RAM)), non-volatile (e.g. read-only memory (ROM)), flash memory, or any combination. System memory 404 may include operating system 405, one or more programming modules 406, and may include a program data 407. Operating system 405, for example, may be suitable for controlling computing device 400's operation. In one embodiment, programming modules 406 may include a camera or photo application. Furthermore, embodiments of the disclosure may be practiced in conjunction with a graphics library, other operating systems, or any other application program and is not limited to any particular application or system. This basic configuration is illustrated in FIG. 4 by those components within a dashed line 408.

Computing device 400 may have additional features or functionality. For example, computing device 400 may also include additional data storage devices (removable and/or non-removable) such as, for example, magnetic disks, optical disks, or tape. Such additional storage is illustrated in FIG. 4 by a removable storage 409 and a non-removable storage 410. Computer storage media may include volatile and nonvolatile, removable and non-removable media implemented in any method or technology for storage of information, such as computer readable instructions, data structures, program modules, or other data. System memory 404, removable storage 409, and non-removable storage 410 are all computer storage media examples (i.e., memory storage.) Computer storage media may include, but is not limited to, RAM, ROM, electrically erasable read-only memory (EEPROM), flash memory or other memory technology, magnetic disk storage or other magnetic storage devices, or any other medium which can be used to store information and which can be accessed by computing device 400. Any such computer storage media may be part of device 100. Computing device 400 may also have input device(s) 412 such as a keyboard, a mouse, a pen, a sound input device, a touch input device, etc. Output device(s) 414 such as a display, speakers, a printer, etc. may also be included. The aforementioned devices are examples and others may be used. One example of a display device is disclosed in an Appendix of the present disclosure.

Computing device 400 may also contain a communication connection 416 that may allow device 400 to communicate with other computing devices 418, such as over a network in a distributed computing environment, for example, an intranet or the Internet. Communication connection 416 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 404, including operating system 405. While executing on processing unit 402, programming modules 406 (e.g., camera/photo application 420) may perform processes including, for example, one or more of method 200's stages as described above. The aforementioned process is an example, and processing unit 402 may perform other processes. Other programming modules that may be used in accordance with embodiments of the present disclosure may include electronic mail and contacts applications, word processing applications, spreadsheet applications, database applications, slide presentation applications, drawing or computer-aided application programs, etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), and an optical fiber. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), a carrier wave from the Internet, or other forms of RAM or ROM. Further, the disclosed methods' stages may be modified in any manner, including by reordering stages and/or inserting or deleting stages, without departing from the disclosure.

All rights including copyrights in the code included herein are vested in and the property of the Applicant. The Applicant retains and reserves all rights in the code included herein, and grants permission to reproduce the material only in connection with reproduction of the granted patent and for no other purpose.

V. Claims

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

The following is claimed:

1. A physical object configured to present contextual information, wherein the physical object is configured to provide a primary functionality, wherein presenting the contextual information constitutes a secondary functionality associated with the physical object, wherein the physical object comprises:
at least one presentation device configured to present contextual information;
at least one of a sensor and a transmitter, wherein the sensor is configured to sense at least one environmental variable corresponding to an environment of the physical object, wherein the transmitter is configured to transmit information to an external reader; and
a processor configured to control the at least one presentation device to present contextual information based on at least one of a value of the at least one environmental variable and information transmitted to the external reader.

2. The physical object of claim 1, wherein the physical object is a storage bag configured to store at least one physical item.

3. The physical object of claim 2, wherein the physical object is a backpack.

4. The physical object of claim 1, wherein the physical object is an article of clothing.

5. The physical object of claim 1, wherein the physical object is configured to be wearable by a person.

6. The physical object of claim 1, wherein the at least one presentation device comprises at least one of a display device and a sound reproduction device.

7. The physical object of claim 1, wherein the at least one presentation device comprises an electronic-ink based display device.

8. The physical object further comprising a solar charging panel configured to convert light energy into electricity for charging a battery.

9. The physical object of claim 1, wherein the sensor comprises a location sensor.

10. The physical object of claim 1, wherein the sensor comprises an RF receiver, wherein the transmitter comprises an RF transmitter.

11. The physical object of claim 1, wherein the sensor comprises at least one activity sensor configured to detect an activity of a user associated with the physical object, wherein the physical object is configured to be worn by the user.

12. The physical object of claim 1, the sensor comprises at least one biometric sensor configured to detect biometric variable of a user associated with the physical object, wherein the physical object is configured to be worn by the user.

13. The physical object of claim 1, wherein the sensor is configured to receive a control signal from an external device, wherein the processor is configured to present the contextual information based on receipt of the control signal.

14. The physical object of claim 1, wherein the contextual information comprises a status associated with the user.

15. The physical object of claim 14, wherein the status comprises a mood of the user.

16. A method comprising:
receiving a selection, via remote computing device, of content to be displayed on a physical object operatively associated with a local computing device;
transmitting, from the remote computing device to the local computing device, the selection of content; and
rendering, by the local computing device, a display of the selection of the content, wherein the display is a flexible display attached to the physical object operatively associated with the local computing device.

17. The method of claim 16, wherein receiving the selection comprises receiving the selection based on, at least in part, a location of the remote computing device.

18. The method of claim 16, wherein receiving the selection comprises receiving the selection based on, at least in part, a proximity of the remote computing device relative to the local computing device.

19. The method of claim 16, wherein transmitting the content comprises transmitting data associated with a user of the local computing device.

20. The method of claim 19, wherein the local computing device is associated with a physical object worn by a user, and wherein the content is associated with data collected on the user by sensors associated with the physical object.
